(19) United States
(12) Patent Application Publication
(10) Pub. No.: US 2002/0031395 A1
(43) Pub. Date: Mar. 14, 2002

(54) Ball sleeve structure

(76) Inventor: Han-Yong Kim, Seoul (KR)

Correspondence Address: Joerg-Uwe Szipl, Griffin & Szipl, P.C., Suite PH-1, 2300 Ninth Street, South, Arlington, VA, 22204-2320, US

(21) Appl. No.: 09/871,687

(22) Filed: Jun. 4, 2001

(30) Foreign Application Priority Data
Jun. 3, 2000 (KR) 2000-15842

(51) Int. Cl. F16D 1/12

(52) U.S. Cl. 403/135

(57) ABSTRACT

Disclosed is a ball sleeve structure. The ball sleeve structure has convex ball portions and grooves. The convex ball portions are formed at the middle of its outer circumference and are tightly coupled within a ball race in a housing of a variety of joints. The grooves are formed at both sides of its outer circumference and are coupled with sealing boots. The ball portions are formed at regular thickness in the whole portions, by swaging predetermined portions in a hollow tube with holes at the center thereof, such that a metal flow is continuously connected. The ball sleeve structure can be simply and easily manufactured and has excellent strength and reduced amount of material, thereby being capable of achieving a reduction in the manufacturing costs and a reduction in the weight of the product.

### BACKGROUND OF THE INVENTION

1. Field of the Invention

The present invention relates to a ball sleeve structure, and more particularly to a ball sleeve structure which is installed within a housing of a variety of joints, such as joints in the steering or suspension system of the automobile.

2. Description of the Related Art

FIG. 1 is a half-sectional view showing coupling of a conventional ball sleeve, FIG. 2 is a sectional view showing the construction of the conventional ball sleeve, and FIG. 3 is an embodiment of manufacturing process of the conventional ball sleeve.

As shown in FIG. 1, in the conventional ball sleeve, ball portions 13a which are inserted into a housing 11 of a variety of joints 10, are slidably arranged with the inner surface of a ball race 12.

To manufacture the conventional ball sleeve 13, as shown in FIGS. 2 and 3, a base material 1 of circular bar is cut to a suitable size, and a perforated hole 1a is formed at the center of the base material 1 using a drilling machine. Thereafter, the section and the outer circumference of the perforated base 1 are lathe turned to form the ball portions 13a being arranged with the inner surface of the ball race 12, and then the outer surface of the ball portions 13a is rolled.

However, the drilling operation for forming holes 1a at the center of the base material 1 is very complex and difficult and needs a lot of working hours. Also, such drilling operation is not precise and wastes extremely much materials.

Also, when the outer circumference of the base material 1 of circular bar is lathe turned to form ball portions 13a at the center of the base material 1, a metal flow 100 inherent in the metal element is interrupted to weaken a brittleness, and thereby degrading the quality and the reliability of the finished product.

Also, since the outer surface of the ball portions 13a is not rolled until the section and the outer circumference of the perforated base material 1 are lathe turned to form the ball portions 13a, the subsequent working operation is delayed and the finished product has heavy weight, compared with the size of the product.

As mentioned in the above, the conventional ball sleeve has a lot of disadvantages.

### SUMMARY OF THE INVENTION

Therefore, an object of the invention is to provide a ball sleeve structure which can be simply and easily manufactured and has excellent strength and reduced amount of material, thereby being capable of achieving a reduction in the manufacturing costs and a reduction in the weight of the product.

In accordance with the present invention, this object is accomplished by providing a ball sleeve structure comprising:

convex ball portions formed at the middle of its outer circumference and tightly coupled within a ball race in a housing of a variety of joints; and

grooves formed at both sides of its outer circumference and coupled with sealing boots,

wherein the ball portions are formed at regular thickness in the whole portions, by swaging predetermined portions in a hollow tube with holes at the center thereof, such that a metal flow is continuously connected.

### BRIEF DESCRIPTION OF THE DRAWINGS

The above objects, and other features and advantages of the present invention will become more apparent after a reading of the following detailed description when taken in conjunction with the drawings, in which:

FIG. 1 is a half-sectional view showing coupling of a conventional ball sleeve;

FIG. 2 is a sectional view showing the construction of the conventional ball sleeve;

FIG. 3 is an embodiment of manufacturing process of the conventional ball sleeve;

FIG. 4 is a half-sectional view showing coupling of the ball sleeve according to the present invention;

FIG. 5 is a sectional view showing the construction of the ball sleeve according to the present invention; and

FIG. 6 is an embodiment of manufacturing process of the ball sleeve according to the present invention.

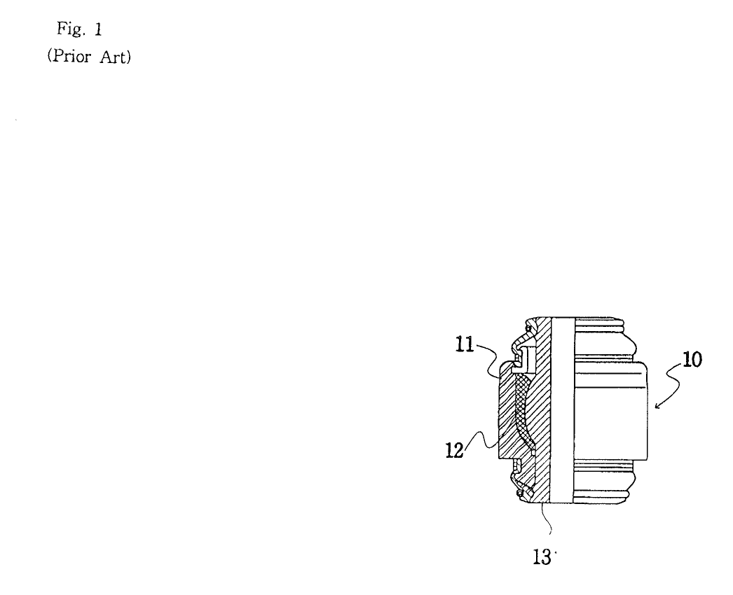

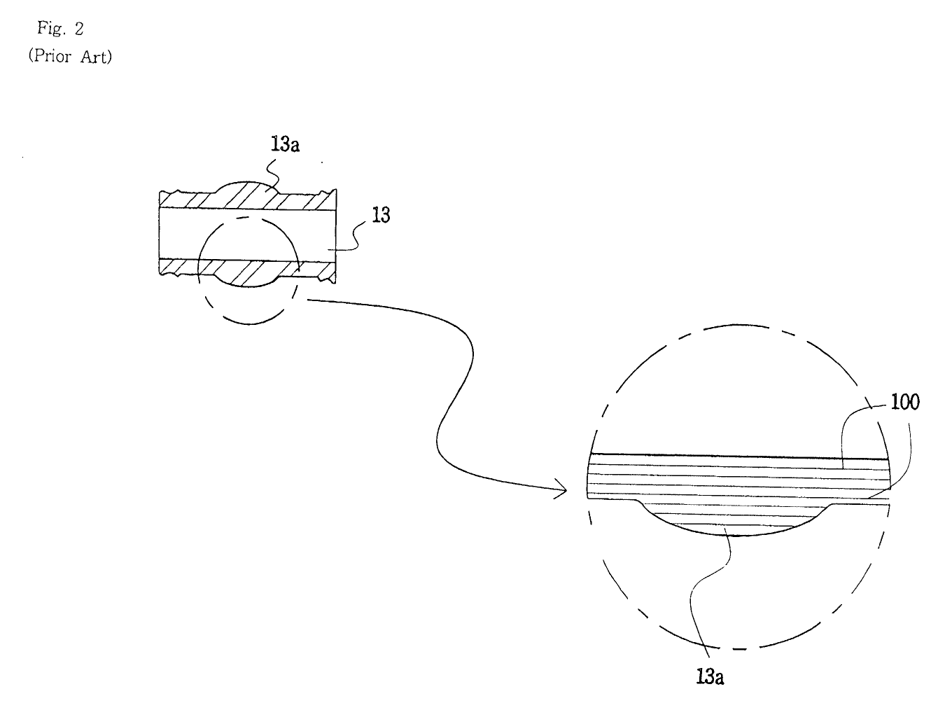

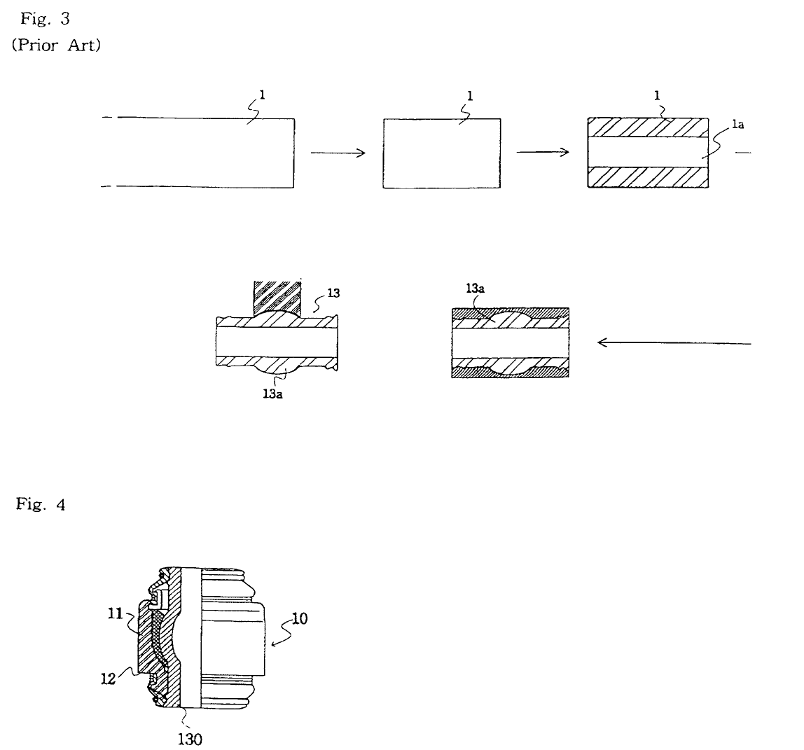

### DESCRIPTION OF THE PREFERRED EMBODIMENTS

Now, the present invention will be described in detail with reference to an embodiment illustrated in FIGS. 4 to 6.

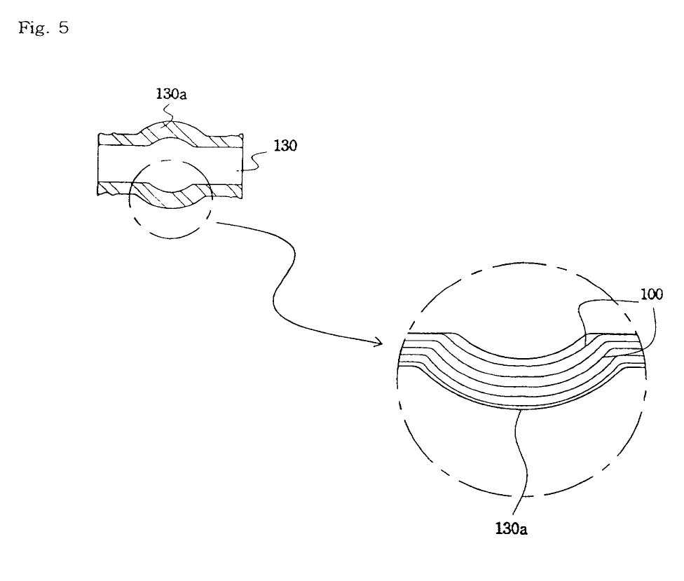

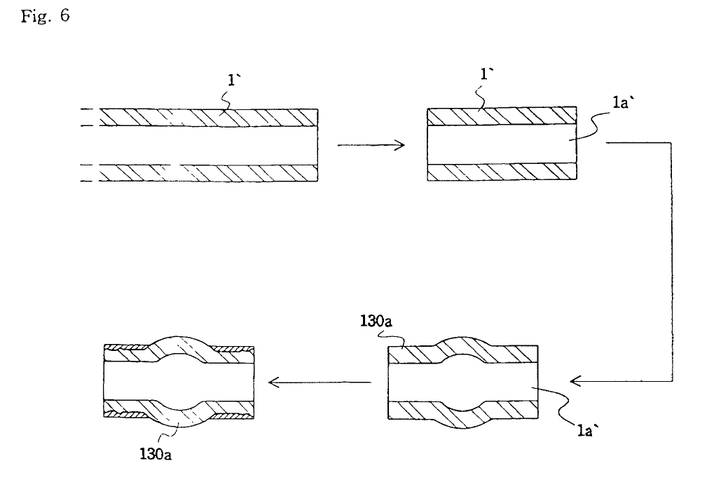

FIG. 4 is a half-sectional view showing coupling of the ball sleeve according to the present invention, FIG. 5 is a sectional view showing the construction of the ball sleeve according to the present invention, and FIG. 6 is an embodiment of manufacturing process of the ball sleeve according to the present invention.

As shown in FIG. 4, the ball sleeve structure has convex ball portions and grooves. The ball portions 130a are formed at the middle of its outer circumference and are tightly coupled with the inner surface of a ball race 12 in a housing 11 of a variety of joints 10. The grooves are formed at both sides of its outer circumference and are coupled with sealing boots. The ball portions 130a are formed at regular thickness in the whole portions, by swaging predetermined portions in a hollow tube 1′ with holes at the center thereof, such that a metal flow 100 is continuously connected.

The manufacturing process of the ball sleeve structure 130 having the above mentioned configuration according to the present invention will be described in more detail.

The base material 1′ of a hollow tube with holes at the center thereof is cut to a suitable size.

The cut base material 1′ of the hollow tube is swaged at its predetermined portion corresponding to the coupling portion by using the conventional swaging machine.

Thereafter, the section and the outer circumference of the swaged base material 1′ are lathe turned to form the ball portions 130a. Finally, the manufacturing process of the ball sleeve structure using the swaging operation is completed.

In manufacturing of the ball sleeve structure 130 according to the present invention, since the base material 1′ of a hollow tube with holes 1a at the center thereof and having a suitable thickness is used, additional drilling operation is not needed, and thus the ball sleeve can be more rapidly and simply manufactured. Also, once the base material 1′ of the hollow tube is swaged at its predetermined portion corresponding to the coupling portion by using the conventional swaging machine, the metal flow is continuously connected even after processing. Thus, the hardening process becomes naturally, the strength of the ball sleeve is improved, and thereby a high quality of light-weighed ball sleeve 130 can be obtained.

As apparent from the above description, the ball sleeve structure according to the present invention can be simply and easily manufactured and has excellent strength and reduced amount of material, thereby being capable of achieving a reduction in the manufacturing costs and a reduction in the weight of the product.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A ball sleeve structure comprising:
convex ball portions formed at the middle of its outer circumference and tightly coupled within a ball race in a housing of a variety of joints; and
grooves formed at both sides of its outer circumference and coupled with sealing boots,
wherein said ball portions are formed at regular thickness in the whole portions, by swaging predetermined portions in a hollow tube with holes at the center thereof, such that a metal flow is continuously connected.
